(19) United States
(12) Patent Application Publication
(10) Pub. No.: US 2011/0208596 A1
(43) Pub. Date: Aug. 25, 2011

(54) METHOD AND SYSTEM FOR PROVIDING ADVERTISING IN WHICH THE BID PRICE PER UNIT TIME IS ADJUSTED IN ACCORDANCE WITH ADVERTISING TRAFFIC

(75) Inventors: Ki Oh Kwon, Seongnam-si (KR); Yuwon Kim, Seongnam-si (KR); Won Sook Noh, Seongnam-si (KR); Woongsup Shin, Seongnam-si (KR); Woosung Lee, Seongnam-si (KR); Min Seon Jeon, Seongnam-si (KR); Seojin Han, Seongnam-si (KR)

(73) Assignee: NHN BUSINESS PLATFORM CORP., Seongnam-si (KR)

(21) Appl. No.: 13/057,397

(22) PCT Filed: Aug. 5, 2009
(86) PCT No.: PCT/KR09/04384

§ 371 Date: May 6, 2011

(30) Foreign Application Priority Data
Aug. 5, 2008 (KR) 10-2008-0076439

(51) Int. Cl. G06Q 30/00

(52) U.S. Cl. 705/14.71

(57) ABSTRACT

A method and system for offering an advertisement by adjusting a bid price per unit time according to advertising traffic are provided. The advertisement offering method includes determining a bid price per unit time based on an average bid price input by an advertiser and advertising traffic, and determining a charge regarding the advertisement of the advertiser based on the bid price per unit time.

### TECHNICAL FIELD

The present invention relates to a method and system for providing advertisement service by adjusting a bid price per unit time according to advertising traffic.

### BACKGROUND ART

Internet advertising, literally, conducting advertisement using the Internet, enables enterprises to contact a great number of consumers at a low cost and to immediately recognize reactions of customers through the advertisement using the merits of the Internet as a medium.

Effects of the internet advertising may vary according to time slots even for the same duration of time. For example, regarding the same advertisement, the advertisement may be exposed to more internet users in the daytime than late at night or early in the morning. Thus, the internet advertising may show different effects according to the time slots during which the advertisement is exposed.

### DISCLOSURE OF INVENTION

### Technical Goals

An aspect of the present invention provides a method and system for offering an advertisement, capable of adjusting a charge for the advertisement according to an effect of the advertisement, which may be varied, even for the same duration of time, by adjusting an average bid price input by an advertiser based on the average bid price and advertising traffic.

Another aspect of the present invention provides a method and system for offering an advertisement, capable of adjusting the charge for the advertisement according to the effect of the advertisement, within a range permitted by the advertiser, by adjusting the average bid price within a range determined based on a minimum bid price and a maximum bid price which are input by the advertiser.

A further aspect of the present invention provides a method and system for offering an advertisement, capable of determining a minimum bid price based on a utility value per unit time of an advertisement region and calculating advertising cost per unit time using a bid price which is input according to the minimum bid price.

### Technical Solutions

According to an aspect of the present invention, there is provided a method for offering an advertisement, including determining a bid price per unit time based on an average bid price input by an advertiser and advertising traffic; and determining a charge regarding the advertisement of the advertiser based on the bid price per unit time.

The determining of the bid price per unit time may include measuring the advertising traffic per unit time; calculating a change rate of the advertising traffic between consecutive unit times; and calculating the bid price per unit time by adjusting the average bid price according to the change rate.

The average bid price may be adjusted within a range determined based on a minimum bid price and an maximum bid price, and the minimum bid price and the maximum bid price may be further input by the advertiser.

The determining of the charge may include calculating the charge based on calculation of at least one bid price per unit time with respect to a unit time during which the advertisement of the advertiser is exposed.

The average bid price may be equal to or greater than a minimum bid price determined, based on a utility value per unit time of an advertisement region. The utility value may be calculated based on advertisement history information related to the advertisement region, and the advertisement history information may include at least one of all types of measurable information related to the advertisement region, such as a number of clicks, a cost per click (CPC), a number of hits, a number of exposures, and a number of purchases.

The method for providing advertisement service may further include determining an advertisement region for exposing the advertisement of the advertiser based on the average bid price; and exposing the advertisement of the advertiser on the determined advertisement region. Here, the determining of the charge may include calculating the charge based on the bid price per unit time, the unit time corresponding to a time slot during which the advertisement of the advertiser is exposed on the advertisement region.

According to an aspect of the present invention, there is provided a system for offering an advertisement, including a unit time bid price determining unit to determine a bid price per unit time based on an average bid price input by an advertiser and advertising traffic; and a charge determining unit to determine a charge for the advertisement of the advertiser based on the bid price per unit time.

### Effects

According to embodiments of the present invention, the average bid price input by an advertiser is adjusted based on the average bid price and advertising traffic. Therefore, a charge for an advertisement may be adjusted according to an effect of the advertisement, which may be varied even for the same duration of time.

According to the embodiments of the present invention, the charge for the advertisement may be adjusted according to the effect of the advertisement, within a range permitted by the advertiser, by adjusting the average bid price within a range determined based on a minimum bid price and a maximum bid price which are input by the advertiser.

In addition, since advertising cost is calculated per unit time using a bid price being input according to a minimum bid price determined based on a utility value per unit time of an advertisement region, rather than being calculated according to a number of clicks of the advertisement. Therefore, problems caused by malicious clicks by a particular user or group may be fundamentally prevented.

### BRIEF DESCRIPTION OF DRAWINGS

FIG. 1 is a diagram schematically illustrating a method for offering an advertisement, according to an embodiment of the present invention;

FIG. 2 is a flowchart illustrating a method for offering an advertisement, according to an embodiment of the present invention;

FIG. 3 is a diagram illustrating an example method for adjusting an average bid price according to advertising traffic;

FIG. 4 is a diagram illustrating an example method for adjusting an average bid price according to advertising traffic using a minimum bid price and a maximum bid price;

FIG. 5 is a diagram illustrating another example of a method for adjusting an average bid price according to advertising traffic;

FIG. 6 is a graph illustrating an example of cost per click (CPC) according to advertisement regions;

FIG. 7 is a graph illustrating an example of a number of clicks according to advertisement regions;

FIG. 8 is a graph illustrating an example of a utility value according to advertisement regions;

FIG. 9 is a block diagram illustrating an inner structure of a system for offering an advertisement, according to an embodiment of the present invention; and

FIG. 10 is a block diagram illustrating an inner structure of a system for selecting an advertisement, of an advertiser, to be exposed using a utility value according to an embodiment of the present invention.

### BEST MODE FOR CARRYING OUT THE INVENTION

Hereinafter, various example embodiments of the present invention will be described in detail with reference to the accompanying drawings.

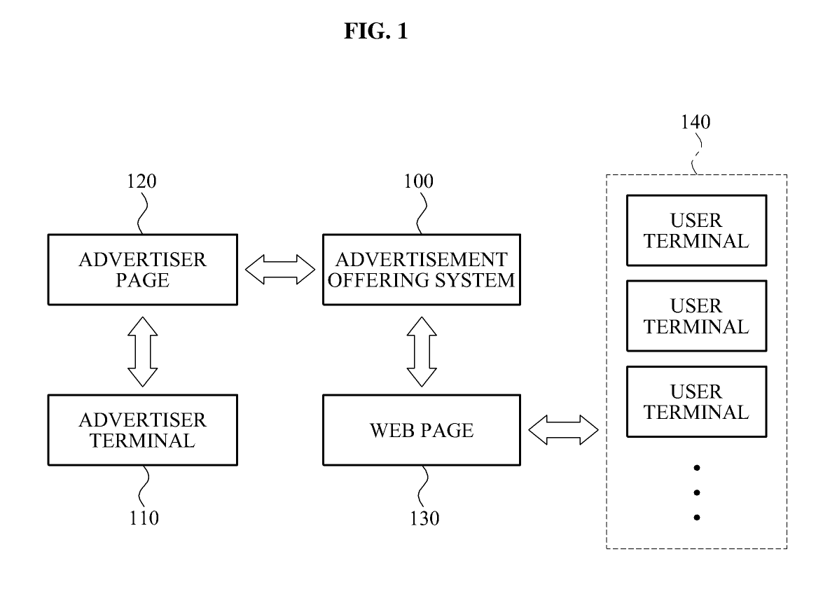

FIG. 1 is a diagram schematically illustrating a method for offering an advertisement, according to an embodiment of the present invention. An advertisement offering system 100 according to the embodiment of the present invention may offer an advertiser page 120 to an advertiser terminal 110 through a wired or wireless network, or offer various web pages 130 to a plurality of user terminals illustrated in a dotted-line box 140. The advertisement offering system 100 may be provided separately from a web page offering system (not shown). In this case, the web page offering system may offer the web pages 130, whereas the advertisement offering system 100 offers an advertisement to an advertisement region in the web pages 130.

The advertisement offering system 100 may expose the advertisement of an advertiser on the advertisement region, by selling the advertisement region accompanying the web pages 130 supplied to the user terminal 140, to the advertiser through the advertiser page 120. In other words, one advertisement region may belong to at least one page of the various web pages 130. When the at least one page is exposed on the user terminal 140, the advertisement of the advertiser may be exposed at the advertisement region which is exposed along with the at least one page. That is, a plurality of the advertisement regions may be sold to the advertiser through an auction using a bid price. Therefore, the advertisement of the advertiser may be exposed at a corresponding advertisement region for a time duration selected by the advertiser.

Here, the advertisement offering system 100 may increase and decrease the bid price based on advertising traffic per unit time, thereby calculating a charge for exposure of the advertisement, since an advertisement effect obtainable to the advertiser during the unit time changes continuously. For example, the advertisement offering system 100 may adjust the bid price according to a change rate of the advertising traffic measured per unit time, and determine the charge for exposure of the advertisement through calculation of at least one bid price according to the unit time. Accordingly, the change of the advertisement effect according to the unit time may be reflected to the charge.

According to one embodiment of the invention, the advertising traffic used for the adjustment of the bid price and the charge may be an indicator representing the performance of the advertisement being offered. For example, a number of exposures of the advertisement to the users, that is, a number of page views (PV) may be used as the performance indicator related to the exposure of the advertisement. A number of reactions of the users to the advertisement (number of clicks), a click through rate (CTR), and the like may also be used as a traffic indicator representing actual user access to the advertisement.

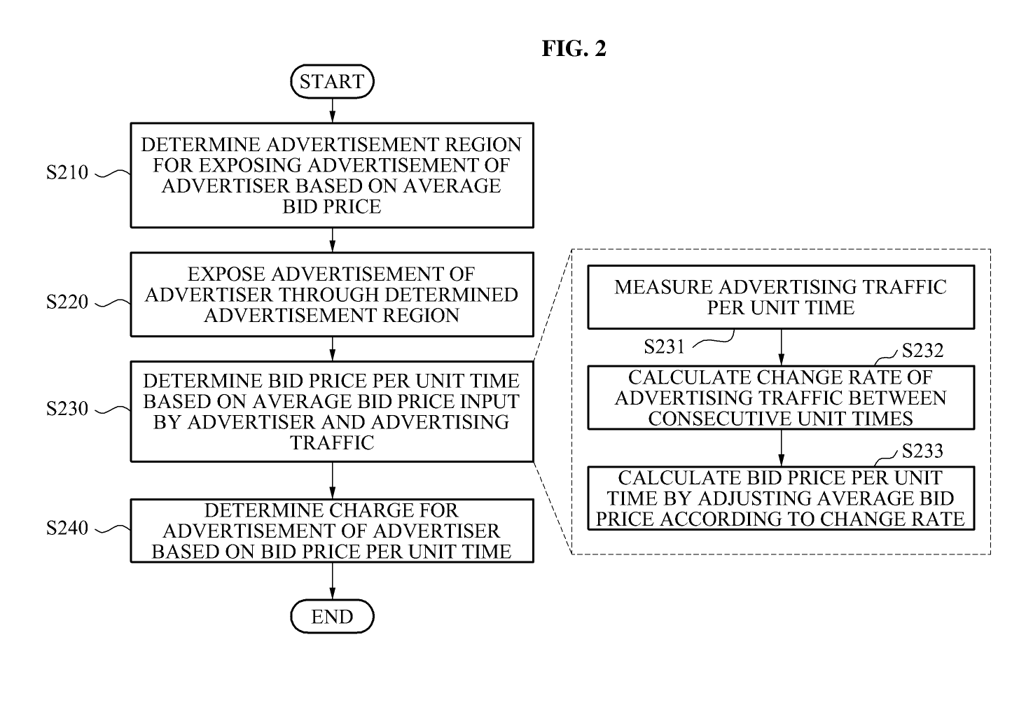

FIG. 2 is a flowchart illustrating a method for offering an advertisement, according to an embodiment of the present invention. The method of the present embodiment may be performed by an advertisement offering system according to an embodiment of the present invention. With reference to FIG. 2, the advertisement offering method will be explained in regard of respective operations performed by the advertisement offering system.

In operation S210, the advertisement offering system determines the advertisement region for exposing the advertisement of the advertiser based on an average bid price. Here, the average bid price may be the bid price explained with reference to FIG. 1 and may be input by the advertiser. The advertisement offering system may determine a utility value according to time, with respect to at least one advertisement region, and determine the advertisement region for exposing the advertisement of the advertiser based on the time and the utility value. For example, the average bid price may be equal to or greater than a minimum bid price based on the utility value per the unit time of the advertisement region. The advertisement offering system may sell the advertisement region using the average bid price input based on the minimum bid price. For example, the advertisement offering system may determine the advertisement region such that, the advertisement region is sold to an advertiser who inputs a highest average bid price among advertisers inputting the average bid price. Here, the utility value may be calculated based on advertisement history information related to the advertisement region. The advertisement history information may include at least one of all types of measurable information related to the advertisement region, such as a number of clicks, a cost per click (CPC), a number of hits, a number of exposures, and a number of purchases.

In the description, the term ‘time’ denotes duration from a specific time point to another time point. Though the ‘time’ may need all temporal data including year, month, day, hour, minute, and second, only the hour or the minute will be considered herein for a convenient explanation. In addition, the specific time point related to a certain advertisement region may be determined as necessary by the advertisement offering system according to the embodiment, an operator of the advertisement offering system, or the advertiser. For example, the advertisement offering system may divide time of one day into 144 unit times of 10 minute intervals, and determine the utility value for each of the unit times. Here, the utility value may be a reference representing utility information of a corresponding advertisement region for a corresponding time. For instance, the minimum cost for use of the corresponding advertisement region for the corresponding time may be used as the utility value. Also, the advertiser may purchase the corresponding advertisement region so that the advertisement of the advertiser is exposed through the corresponding advertisement region for a desired unit time selected from the 144 unit times, for example, for three unit times from 12:30 to 13:00 or four unit times from 15:00 to 15:40. Thus, as purchase of the advertisement region is made based on the time and the utility value according to the time, the advertiser may be able to obtain the advertisement effect efficiently and reasonably. A method of calculating the utility value will be described in further detail hereinafter.

In operation S220, the advertisement offering system exposes the advertisement of the advertiser through the determined advertisement region. For example, the advertisement may be exposed to the users on the user terminals using the corresponding advertisement region among the advertisement regions exposed on at least one of the various web pages 130, of FIG. 1.

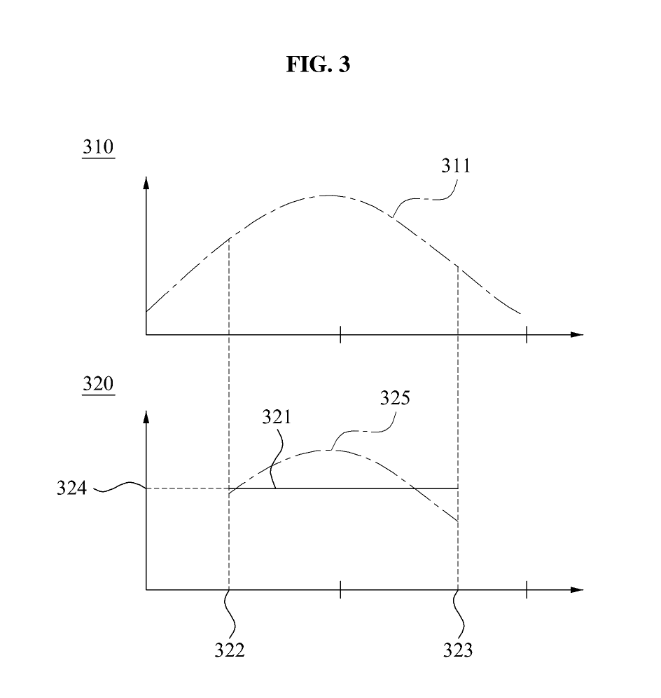

In operation S230, the advertisement offering system may determine a bid price per unit time based on the average bid price input by the advertiser and also based on the advertising traffic. Here, the advertisement offering system may calculate the bid price per unit time by adjusting the average bid price according to the advertising traffic. FIG. 3 shows an example case where the average bid price is adjusted according to the advertising traffic. In a graph 310, an x-axis denotes time and a y-axis denotes an amount of the advertising traffic. That is, a first dot dashed line 311 of the graph 310 illustrates an example of the advertising traffic according to the time. In a graph 320, an x-axis denotes time and a y-axis denotes an amount of the bid price. That is, a solid line 321 of the graph 320 illustrates an example of the average bid price 324 with respect to a time from a first time point 322 to a second time point 323. The average bid price 324 is constant for the above time. In this case, the advertisement offering system may adjust the average bid price 324 shown by the solid line 321 based on the advertising traffic, thereby adjusting the average bid price 324 per unit time. For example, a plurality of unit times may be included in a time range from the first time point 322 to the second time point 323. In this case, the average bid price 324 per unit time may be adjusted according to the advertising traffic and determined as the bid price per unit time. In other words, a second dot dashed line 325 shown in the graph 320 may indicate the bid price per unit time according to the time.

The ‘average bid price’ input by the advertiser may not precisely correspond to an arithmetically calculated average of the bid price which varies according to information on the advertising traffic, that is, the advertising traffic information. That is, since the bid price, input by the advertiser and applied for bidding per unit time, may vary according to the advertising traffic information, the term ‘average bid price’ may be understood as an average bid price or reference bid price, expected by the advertiser to acquire a right to expose an advertisement of a bid object for the unit time. In other words, the ‘average bid price’ mentioned herein may be substituted by other terms such as the ‘reference bid price’ or an ‘expected contract price.’

As shown in FIG. 2, in order to determine the bid price per unit time based on the average bid price and the advertising traffic, the advertisement offering system may perform operation S230 including operation S231 for measuring the advertising traffic per unit time, operation S232 for calculating a change rate of the advertising traffic between consecutive unit times, and operation 233 for calculating the bid price per unit time by adjusting the average bid price according to the change rate. More specifically, the advertisement offering system may calculate the bid price per unit time, by calculating the change rate of the advertising traffic measured with respect to consecutive unit times and adjusting the average bid price of a desired is unit time based on the change rate. For example, when the average bid price with respect to the desired unit time is ‘1,000 won’ and the change rate is ‘1.2’, the bid price per unit time may be calculated as ‘1,200 won.’

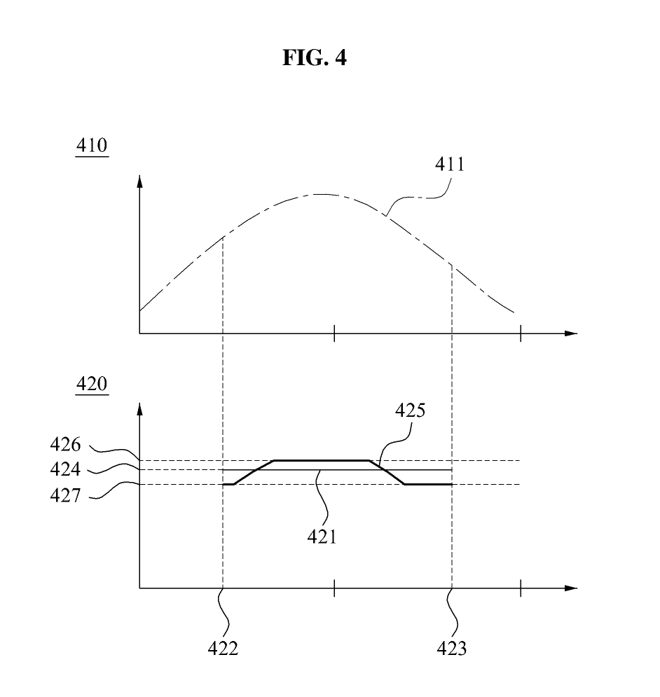

Additionally, the average bid price may be adjusted within a range determined based on a minimum bid price and a maximum bid price. In other words, the bid price per unit time may be within a range defined by the minimum bid price and the maximum bid price. Here, the minimum bid price and the maximum bid price may be additionally input by the advertiser. FIG. 4 is a diagram illustrating an example of a method for adjusting an average bid price according to advertising traffic using a minimum bid price and a maximum bid price. In a graph 410, an x-axis denotes time and a y-axis denotes an amount of the advertising traffic. That is, a dot dashed line 411 indicates an example advertising traffic according to time. In a graph 420, an x-axis denotes time and a y-axis denotes an amount of the bid price. That is, a first solid line 421 of the graph 420 illustrates an example of an average bid price 424 input by the advertiser with respect to a time from a first time point 422 to a second time point 423. The average bid price 424 is constant for the above time. Here, a second solid line 425 illustrates the bid price per unit time according to the time, being determined by adjusting the average bid price 424 according to the advertising traffic within the range between the maximum bid price 426 and the minimum bid price 427 that may be further input by the advertiser. In other words, a plurality of the unit times may be included in the time range from the first time point 422 to the second time point 423. The bid price per unit time may be determined as the average bid price 424 is adjusted according to the advertising traffic, the maximum bid price 426, and the minimum bid price 427, as shown by the second solid line 425. In other words, the bid price per unit time may be determined for every unit time based on the average bid price 424 and the advertising traffic, within the range defined by the maximum bid price 426 and the minimum bid price 427.

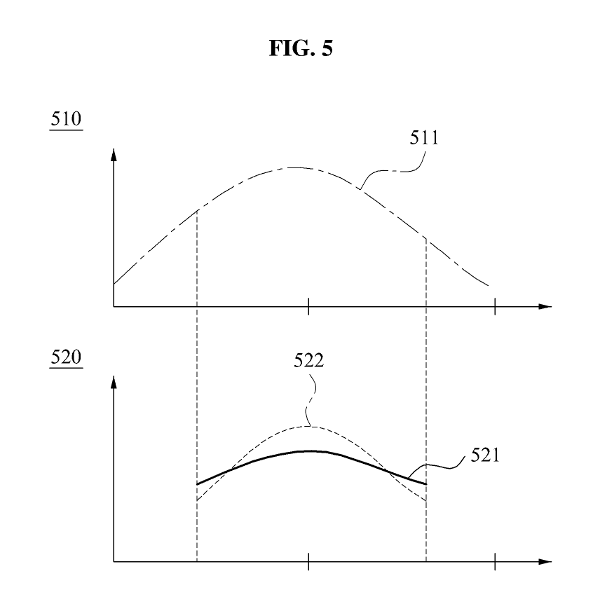

The average bid price input by the advertiser may be different according to the unit time. In this case as well, the advertisement offering system may determine the bid price per unit time based on the average bid price and the advertising traffic. FIG. 5 shows another example where an average bid price is adjusted according to advertising traffic. In a graph 510, an x-axis denotes time and a y-axis denotes an amount of the advertising traffic. That is, a dot dashed line 511 of the graph 510 illustrates an example of the advertising traffic according to the time. In a graph 520, an x-axis denotes time and a y-axis denotes an amount of the bid price. In this case, a solid line 521 of the graph 520 may illustrate an average bid price input per unit time by the advertiser. A dotted line 522 may illustrate a bid price per unit time according to the time, being calculated by increasing and decreasing the average bid price. The increase and decrease of the average bid price may be performed based on the change rate of the advertising traffic between consecutive unit times. In this case as well, the range of the bid price per unit time may be adjusted using a minimum bid price and a maximum bid price input by the advertiser, as explained with reference to FIG. 4.

The advertising traffic may include any one of an actual traffic, actually measured for a corresponding time, an expected traffic, calculated with respect to the time, and a past advertising traffic, related to a corresponding advertised product. According to an advertising method where the charge is determined after exposure of the advertisement, the bid price per unit time may be determined using the actual traffic. According to another advertising method where the charge is determined prior to exposure of the advertisement, the bid price per unit time may be determined using the expected traffic.

The expected traffic may be calculated using one of various traffic expecting methods. For example, the traffic of an n-th time duration may be expected using the traffic measured during an (n−1)-th time duration. As another example, traffic of time from 3 o'clock and 4 o'clock of today may be expected using traffic measured during time from 3 o'clock to 4 o'clock of a previous day, and may be used as the expected traffic.

In operation S240, the advertisement offering system may determine the charge for the advertisement of the advertiser based on the bid price per unit time. Here, the advertisement offering system may calculate the charge through calculation of at least one bid price per unit time with respect to at least one unit time during which the advertisement is exposed. For example, when the advertiser exposes the advertisement for three unit times through a certain advertisement region, and the bid prices per unit time of each of the three unit times are ‘850 won’, ‘1,000 won’, and ‘1,150 won’, the advertisement offering system may calculate the charge for exposure of the advertisement as ‘3,000 won’ by adding those bid prices. In other words, the bid price per unit time may mean a contract price, that is, a highest successful bid among bid prices input by advertisers for exposure of their advertisements for the corresponding unit time.

As described above, the advertisement offering method according to the embodiments adjusts the average bid price based on the average bid price input by the advertiser and the advertising traffic, thereby adjusting the charge for the advertisement depending on the advertisement effect which may be varied even for the same duration of time. Also, since a minimum bid price and a maximum bid price are input by the advertiser and the average bid price is adjusted within the range defined by the minimum bid price and the maximum bid price, the charge may be adjusted according to the advertisement effect within a range permitted by the advertiser. In addition, since advertising cost is calculated per unit time, using the average bid price being input according to the minimum bid price determined, based on a utility value per unit time of the advertisement region, rather than being calculated according to a number of clicks of the advertisement. Therefore, problems caused by malicious clicks by one particular user or group may be fundamentally prevented.

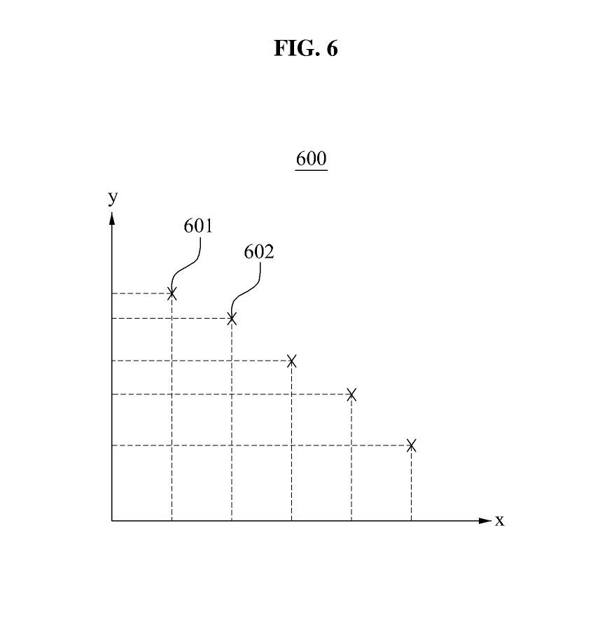

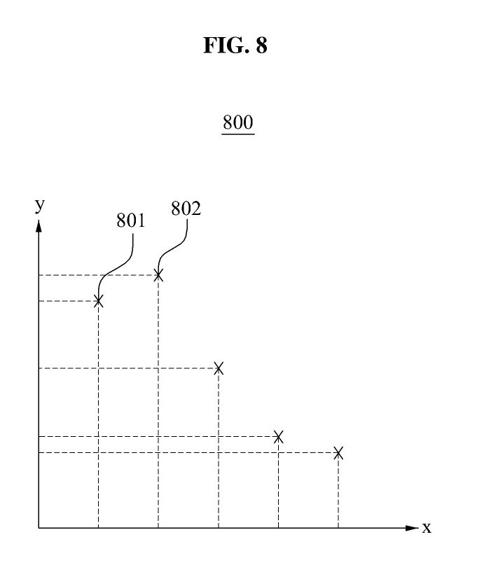

Hereinafter, an example of calculating the utility value based on the number of clicks and the CPC as the advertisement history information will be briefly explained with reference to FIGS. 6 and 8.

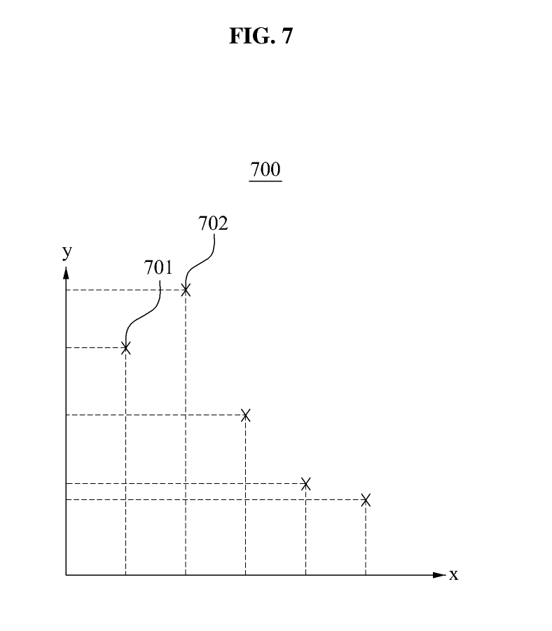

FIG. 6 is a graph 600 illustrating an example of the CPC according to advertisement regions. FIG. 7 is a graph 700 illustrating an example of the number of clicks according to advertisement regions. FIG. 8 is a graph 800 illustrating an example of the utility value according to advertisement regions. In the graph 600 of FIG. 6, an x-axis denotes the advertisement region and a y-axis denotes the CPC. For example, a first coordinate 601 shows ‘100 won’ as the CPC in a first advertisement region. A second coordinate 602 shows ‘90 won’ as the CPC in a second advertisement region. In the graph 700 of FIG. 7, an x-axis denotes the advertisement region and a y-axis denotes the number of clicks. Here, the number of clicks may include an average number of clicks per unit time, which is calculated with respect to the entire measured time where the time is used as the unit time. For example, a third coordinate 701 shows ‘10 times’ as the average number of clicks occurring with respect to a first advertisement region with a unit time of 30 minutes. A fourth coordinate 702 shows ‘12 times’ as the average number of clicks occurring with respect to a second advertisement region with a unit time of 30 minutes. Last, in the graph 800 of FIG. 8, an x-axis denotes the advertisement region and a y-axis denotes the utility value. For example, a fifth coordinate 801 shows ‘1,000 won’ as the utility value with respect to a first advertisement region, calculated by multiplying the ‘100 won’ as the CPC by the ‘10 times’ as the number of clicks. A sixth coordinate 802 shows ‘1,080 won’ as the utility value with respect to a second advertisement region, calculated by multiplying the ‘90 won’ as the CPC by the ‘12 times’ as the number of clicks. That is, the utility value may be used for sale of the advertisement region, as an indicator representing utility per the advertisement region.

The utility value may be determined according to a bid object keyword to be bid by the advertiser. For example, the utility value with respect to a unit time (duration for exposure of an advertisement) of the bid object keyword may be determined using data related to a number of searches for the bid object keyword and the number of clicks of the advertisement using the bid object keyword. In the present embodiment, in operation S201, the advertisement offering system may calculate the utility value with respect to the unit time of the bid object keyword, based on the advertisement history information of the bid object keyword. As described above, the advertisement history information may include at least one of all types of measurable information related to the bid object keyword, such as the number of clicks, the CPC, the number of hits, the number of exposures, and the number of purchases. For example, additionally, an average CPC of the bid object keyword and an average number of clicks corresponding to the time for exposing the advertisement may be used as the advertisement history information. The above-described method for determining the utility value with respect to the advertisement region may also be applied as a method for determining the utility value with respect to the bid object keyword.

Bidding with respect to the keyword will be briefly described below. Hereinafter, specific date, day, and hour will be cited only by way of example. Therefore, besides the date, day, and hour cited hereinafter, various altered forms may be applied.

\textcircled{1} Regular Bidding

For example, the regular bidding may be closed at 3 pm every Wednesday and an advertisement may be exposed for 7 days from midnight the next day, that is, on Thursday. The advertiser may be notified of the result of the bidding by e-mail or a mobile phone message. Since, regular bidding starts right after the previous regular bidding of Wednesday at 3 pm, the advertiser may participate in the next regular bidding even though the advertiser failed in making a successful bid.

When the bidding is thus weekly performed, the advertiser may participate in bidding about 50 times a year, which will be cumbersome for the advertiser to set the bid price at every time of bidding. If the regular bidding is performed daily or hourly, setting of the bid price will become even more cumbersome.

According to the embodiment, the advertiser may participate in the bidding once or several times, by suggesting a predetermined reference bid price, that is, the average bid price. For example, the advertiser may suggest a reference bid price, that is, the average bid price according to his or her budget scale with respect to at least one bid belonging to a predetermined period. The suggested reference bid price may be revised based on the advertising traffic information. The right to expose the advertisement may be sold according to the revised bid price. The revised bid price may be used as basic data for calculating the charge for the right to expose the corresponding advertisement. Such a bidding function may be offered as an automatic bidding function.

As aforementioned, the advertising traffic used for adjustment of the bid price, which finally influences the charge of the advertisement, may represent the performance indicator with respect to the advertisement region or an advertisement keyword, which is the bid object. Indicators such as the number of PVs, the number of clicks, the CTR, a purchase conversion rate, and the like may be used as the advertising traffic information, to adjust the bid price.

The measured advertising traffic information may be reflected during bidding performed after the measurement. For example, when the bid object is a right to expose an advertisement regarding Christmas shopping season, advertising traffic measured last Christmas shopping season may be reflected. The measured advertising traffic information may be reflected to bidding performed after the measurement. For example, when the bid object is a right to expose an advertisement regarding a Christmas shopping season, advertising traffic measured last Christmas shopping season may be reflected. Also, information on ‘expected advertising traffic’ based on predetermined advertising traffic obtained before a unit time of the bid object may be used in adjusting the bid price. As described above, the measured advertising traffic information may also be used for adjusting the charge with respect to the unit time including a time zone during which the advertising traffic is measured.

\textcircled{2} Irregular Bidding

The irregular bidding, that is, additional bidding may be performed everyday for remaining publication days (7-DAY) with respect to keywords passed or cancelled for bidding. When any keyword needs to be exposed even for a short time, the advertiser may expose the corresponding advertisement through the irregular bidding even after the regular bidding is closed. Information on a number or type of the used or cancelled keywords may be supplied through a dedicated management page, thereby enabling the advertiser to participate in the irregular bidding.

\textcircled{3} Automatic Bidding

The automatic bidding enables more convenient management of advertising for the advertiser who wants keyword advertising at a minimum management cost. The advertiser who uses the automatic bidding may manage advertising according to advertisement groups. In addition, the advertiser may automatically participate in the regular bidding without having to checking a bidding state every time, through a bidding on/off function and an additional bidding participation option. When using the additional bidding participation option, the advertiser may be able to automatically participate in the irregular bidding caused by various reasons.

When the utility value with respect to the advertisement region or the bid object keyword is determined as illustrated with FIGS. 6 through 8, the advertisement offering system may determine a minimum bid price with respect to the advertisement region based on the utility value and may be input with the average bid price by the advertiser based on the minimum bid price.

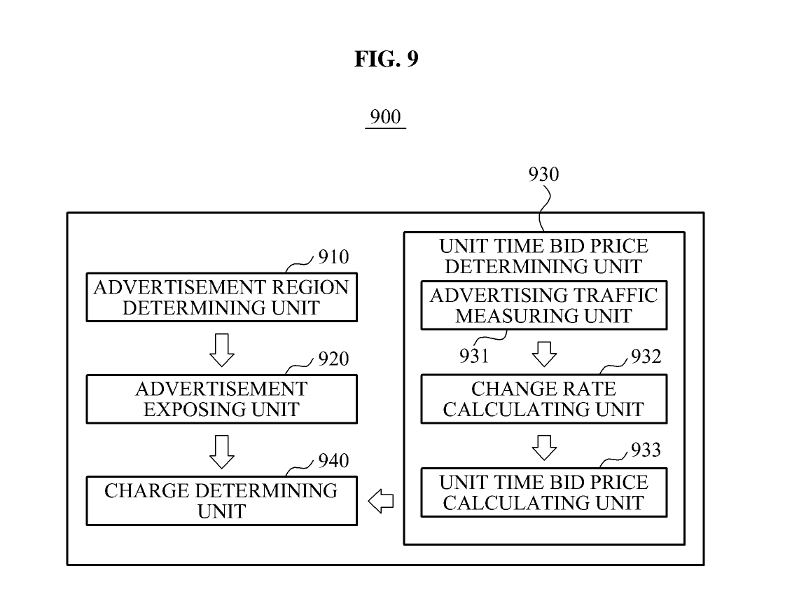

FIG. 9 is a block diagram illustrating an inner structure of an advertisement offering system 900 according to an embodiment of the present invention. The advertisement offering system 900 according to the embodiment of the invention includes an advertisement region determining unit 910, an advertisement exposing unit 920, a unit time bid price determining unit 930, and a charge determining unit 940, as shown in FIG. 9.

The advertisement region determining unit 910 determines an advertisement region to expose an advertisement of the advertiser based on an average bid price. The average bid price, which is input by the advertiser, may be the bid price explained with reference to FIG. 1. The advertisement region determining unit 910 may determine a utility value according to time with respect to at least one advertisement region, and determine the advertisement region for exposing the advertisement of the advertiser based, on the time and the utility value. For example, the average bid price may be equal to or greater than a minimum bid price which is determined based on the utility value per unit time of the advertisement region. Therefore, the advertisement region determining unit 910 may sell the advertisement region through the average bid price input based on the minimum bid price. For example, the advertisement region determining unit 910 may determine the advertisement region such that the advertisement region is sold to an advertiser who inputs a highest average bid price among advertisers inputting the average bid price. Here, the utility value may be calculated based on advertisement history information related to the advertisement region. The advertisement history information may include at least one of all types of measurable information related to the advertisement region, such as a number of clicks, a CPC number of hits, a number of exposures, and a number of purchases.

The advertisement exposing unit 920 may expose the advertisement of the advertiser through the determined advertisement region. For example, the advertisement may be exposed to users on user terminals using a corresponding advertisement region among the advertisement regions exposed on at least one of the various web pages 130 explained with FIG. 1.

The unit time bid price determining unit 930 may determine a unit time bid price based on the average bid price input by the advertiser and based on advertising traffic. Here, the unit time bid price determining unit 930 may calculate the bid price per unit time by adjusting the average bid price according to the advertising traffic. For this purpose, as shown in FIG. 2, the unit time bid price determining unit 930 may include an advertising traffic measuring unit 931 to measure the advertising traffic per unit time, a change rate calculating unit 932 to calculate a change rate of the advertising traffic between consecutive unit times, and a unit time bid price calculating unit 933 to calculate the bid price per unit time by adjusting the average bid price according to the change rate. That is, the unit time bid price determining unit 930 may calculate the change rate of the advertising traffic measured per unit time, and adjust the average bid price of a corresponding unit time based on the change rate, accordingly calculating the bid price per unit time. For example, when the average bid price with respect to a certain unit time is ‘1,000 won’ and the change rate is ‘0.8’, the bid price per unit may be calculated as ‘800 won.’

In addition, the average bid price may be adjusted within a range determined based on the minimum bid price and a maximum bid price. The minimum bid price and the maximum bid price may be additionally input by the advertiser. In other words, the bid price per unit time may be within the range defined by the minimum bid price and the maximum bid price. The average bid price input by the advertiser may be varied according to the unit time. In this case as well, the unit time bid price determining unit 930 may determine the bid price per unit time based on the average bid price and the advertising traffic.

The charge determining unit 940 may determine a charge for the advertisement of the advertiser, based on the bid price per unit time. Specifically, the charge determining unit 940 may calculate the charge based on at least one bid price per unit time with respect to at least one unit time during which the advertisement is exposed. For example, when the advertiser exposes the advertisement for three unit times on a certain advertisement region, and the bid prices per unit time of each of the three unit times are ‘850 won’, ‘1,000 won’, and ‘1,150 won’, the charge determining unit 940 may calculate the charge for exposure of the advertisement for the three unit times as ‘3,000 won’ by adding the respective bid prices per unit time.

Thus, using the advertisement offering system according to the embodiment of the present invention, since the average bid price may be adjusted based on the average bid price input by the advertiser and the advertising traffic, the charge for the advertisement may be adjusted according to the advertisement effect that may vary even for the same duration of time. Also, since a minimum bid price and a maximum bid price are input by the advertiser and the average bid price is adjusted within the range determined based on the minimum bid price and the maximum bid price, the charge may be adjusted according to the advertisement effect within a range permitted by the advertiser. In addition, since advertising cost is calculated per unit time using the average bid price being input according to the minimum bid price determined based on a utility value per unit time of the advertisement region, rather than being calculated according to a number of clicks of the advertisement. Therefore, problems caused by malicious clicks by one particular user or group may be fundamentally prevented.

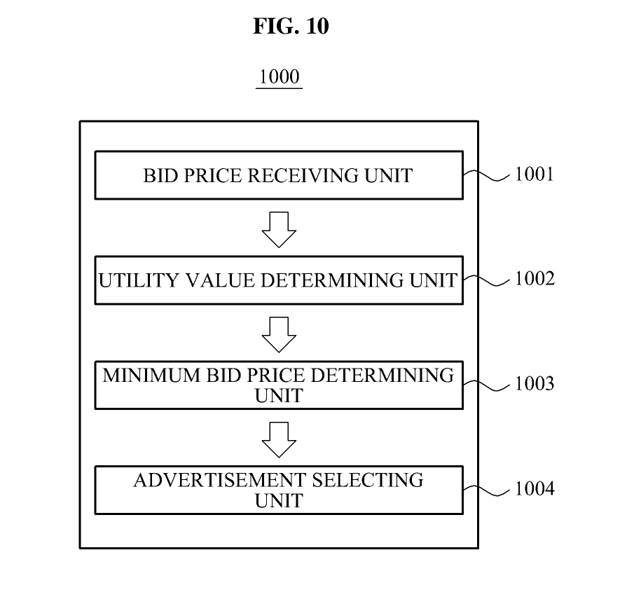

FIG. 10 is a block diagram illustrating an inner structure of a system 1000 for selecting an advertisement to be exposed, of an advertiser, using a utility value, according to an embodiment of the present invention. Component elements of the advertisement select system 1000 may be included in the advertisement offering system 900 explained with FIG. 9. The advertisement select system 1000 may include a bid price receiving unit 1001, a utility value determining unit 1002, a minimum bid price determining unit 103, and an advertisement selecting unit 1004, as shown in FIG. 10.

The bid price receiving unit 1001 may receive a bid price according to time with respect to at least one advertisement region through a wired or wireless network. The time herein may be set by the advertisement select system 1000, an operator of the advertisement select system 1000, or the advertiser. The bid price may be received through an advertiser terminal of the advertiser intending to expose the advertisement through the advertisement region for the time.

The utility value determining unit 1002 may determine the utility value according to the time with respect to the advertisement region. Specifically, the utility value determining unit 1002 may calculate the utility value based on advertisement history information with respect to the advertisement region. The advertisement history information may include at least one of all types of measurable information related to the advertisement region, such as a number of clicks, a CPC, a number of hits, a number of exposures, and a number of purchases.

For example, when the number of clicks and the CPC may be used as the advertisement history information, the number of clicks may include an average number of clicks per unit time, calculated with respect to the entire measured time where the time is used as the unit time. Alternatively, the number of clicks may be determined based on a number of clicks occurring in the advertisement region for a previous time having the same duration as the time. In this case, the utility value may be calculated based on the CPC and the number of clicks.

The minimum bid price determining unit 1003 may determine the minimum bid price based on the utility value. For example, the minimum bid price determining unit 1003 may use the utility value as the minimum bid price or determine the minimum bid price by applying a predetermined weight to the utility value. Here, both the minimum bid price and the bid price may be effective in the advertisement region only at the corresponding time. In other words, the minimum bid price may be changed at other times even with the same advertisement region. Therefore, a bid price for the other times may be required to be received again.

The advertisement selecting unit 1004 may select the advertisement of the advertiser, which is to be exposed at the advertisement region for the time, based on the bid price. For example, the advertisement selecting unit 1004 may select an advertisement of an advertiser who suggests a highest bid price or a second highest bid price, as the advertisement to be exposed through the advertisement region. The advertisement region may be included in a fixed position on a search result page for a keyword corresponding to the advertisement or on a homepage. The advertisement of the advertiser may be exposed at the advertisement region.

The advertisement select system 1000 according to another embodiment may operate as follows. As shown in FIG. 10, the advertisement select system 1000 according to the another embodiment may include the bid price receiving unit 1001, the utility value determining unit 1002, the minimum bid price determining unit 1003, and the advertisement selecting unit 1004.

The bid price receiving unit 1001 may receive a bid price suggested by the advertiser with respect to a unit time. The bid price may be equal to or greater than a minimum bid price that will be explained hereinafter.

The unit time may refer to time duration during which the advertisement of the advertiser is exposed. Advertising cost and an advertisement exposure order may be fixed during the unit time exposing the advertisement.

The utility value determining unit 1002 may determine the utility value of a bid object keyword, corresponding to the unit time. The utility value determining unit 1002 may determine the utility value with respect to the unit time of the bid object keyword, using data related to a number of searches for the bid object keyword and a number of clicks of the advertisement using the bid object keyword. The utility value determining unit 1002 may calculate the utility value with respect to the unit time of the bid object keyword, based on advertisement history information of the bid object keyword. As described above, the advertisement history information may include at least one of all types of measurable information related to the bid object keyword, such as a number of clicks, a CPC, a number of hits, a number of exposures, and a number of purchases. For example, an average CPC of the bid object keyword and an average number of clicks corresponding to the time for exposing the advertisement may be used as the advertisement history information. The above-described method for determining the utility value with respect to the advertisement region may also be applied as a method for determining the utility value with respect to the bid object keyword.

The minimum bid price determining unit 1003 may determine the minimum bid price using the utility value corresponding to the unit time of the bid object keyword. The minimum bid price determining unit 1003 may use the utility value as the minimum bid price, or determine the minimum bid price by applying a predetermined weight to the utility value. For example, in a case of bidding of a keyword for exposing the advertisement for the unit time of ‘7 days’, the minimum bid price determining unit 1003 may determine the minimum bid price of the bid object keyword as “average CPC X average expected number of clicks for 7 days.”

The advertisement selecting unit 1004 may determine the advertising cost and the advertisement exposure order according to the bid price being received. As aforementioned, the unit time refers to time duration for exposing the advertisement of the advertiser. The advertising cost and the advertisement exposure order may be fixed during the unit time for exposing the advertisement. Also, the advertisement selecting unit 1004 may offer the advertisement by giving priority to advertisers in order of highest bid price. In this case, for example, the advertisements of a first advertiser to a fifth advertiser may be offered in a first advertisement region to a fifth advertisement region included in the quadrangular box 703. According to the present embodiment, order of the advertisers may be determined in order of the highest bid price. However, actual cost paid by the advertiser may be determined by a bid price of a next-order advertiser. In this case, the actual cost of the advertiser may be the same as the bid price of the next-order advertiser. Otherwise, the actual cost may be a price obtained by adding the bid price of the next-order advertiser to a minimum bid adjusting unit. That is, “actual cost=bid price of next-order advertiser+minimum bid adjusting unit” may be satisfied.

The minimum bid adjusting unit may be set by the operator of the advertisement offering system. The minimum bid adjusting unit refers to a factor for adjusting the actual cost of the advertiser to be slightly higher than the bid price of the next-order advertiser. For example, the minimum bid adjusting unit may be determined based on a unit of the bid price of the advertiser. For example, assuming that the minimum bid adjusting unit is determined as 1/100 of the unit of the bid price of the advertiser, when the unit of the bid price of the advertiser is 100 hundred won, the minimum bid adjusting unit becomes 1,000 won. For another example, when the unit of the bid price is a 10,000 won, the minimum bid adjusting unit becomes 100 won. This will be understood through Table 1 below.

TABLE 1

| Exposure | Bid | |
|---|---|---|
| order | amount | Actual cost |
| First | 101,000 won | 10,100 won + 1,000 won |
| Second | 10,100 won | 9,010 won + 100 won |
| Third | 9,010 won | Next order bid amount + Adjusting unit |

The methods according to the above-described example embodiments may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the example embodiments, or they may be of the kind well-known and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. The media may be transfer media such as optical lines, metal lines, or waveguides including a carrier wave for transmitting a signal designating the program command and the data construction. Examples of program instructions include both machine code, such as produced by a compiler, and files containing higher level code that may be executed by the computer using an interpreter. The described hardware devices may be configured to act as one or more software modules in order to perform the operations of the above-described example embodiments, or vice versa.

Although a few embodiments of the present invention have been shown and described, the present invention is not limited to the described embodiments. Instead, it would be appreciated by those skilled in the art that changes may be made to these embodiments.

Accordingly, the principles and spirit of the invention should not be limited to the embodiments described above, and they are defined by the claims and their equivalents.

1. A method for offering an advertisement, comprising:
determining a bid price per unit time based on an average bid price input by an advertiser and advertising traffic; and
determining a charge regarding the advertisement of the advertiser based on the bid price per unit time.

2. The method of claim 1, wherein the determining of the bid price per unit time comprises:
measuring the advertising traffic per unit time;
calculating a change rate of the advertising traffic between consecutive unit times; and
calculating the bid price per unit time by adjusting the average bid price according to the change rate.

3. The method of claim 1, wherein
the average bid price is adjusted within a range determined based on a minimum bid price and a maximum bid price, and
the minimum bid price and the maximum bid price are further input by the advertiser.

4. The method of claim 1, wherein the determining of the charge comprises:
calculating the charge based on calculation of at least one bid price per unit time with respect to a unit time during which the advertisement of the advertiser is exposed.

5. The method of claim 1, wherein the average bid price is equal to or greater than a minimum bid price determined based on a utility value per unit time of an advertisement region.

6. The method of claim 5, wherein
the utility value is calculated based on advertisement history information related to the advertisement region, and
the advertisement history information comprises at least one of all types of measurable information related to the advertisement region, such as a number of clicks, a cost per click (CPC), a number of hits, a number of exposures, and a number of purchases.

7. The method of claim 1, further comprising:
determining an advertisement region for exposing the advertisement of the advertiser based on the average bid price; and
exposing the advertisement of the advertiser on the determined advertisement region.

8. The method of claim 7, wherein the determining of the charge comprises calculating the charge based on the bid price per unit time, the unit time corresponding to a time slot during which the advertisement of the advertiser is exposed on the advertisement region.

9. A non-transitory computer readable recording medium storing a program to cause a computer to implement the method of any of claim 1 to claim 8.

10. A system for offering an advertisement, comprising:
a unit time bid price determining unit to determine a bid price per unit time based on an average bid price input by an advertiser and advertising traffic; and
a charge determining unit to determine a charge for the advertisement of the advertiser based on the bid price per unit time.

11. The system of claim 10, wherein the unit time bid price determining unit comprises:
an advertising traffic measuring unit to measure the advertising traffic per unit time;
a change rate calculating unit to calculate a change rate of the advertising traffic between consecutive unit times; and
a unit time bid price calculating unit to calculate the bid price per unit time by adjusting the average bid price according to the change rate.

12. The system of claim 10, wherein
the average bid price is adjusted within a range determined based on a minimum bid price and an maximum bid price, and
the minimum bid price and the maximum bid price are further input by the advertiser.

13. The system of claim 10, wherein the charge determining unit is configured to calculate the charge based on calculation of at least one bid price per unit time with respect to a unit time during which the advertisement of the advertiser is exposed.

14. The system of claim 10, wherein the average bid price is equal to or greater than a minimum bid price determined based on a utility value per unit of an advertisement region.

15. The system of claim 14, wherein
the utility value is calculated based on advertisement history information related to the advertisement region, and
the advertisement history information comprises at least one of all types of measurable information related to the advertisement region, such as a number of clicks, a cost per click (CPC), a number of hits, a number of exposures, and a number of purchases.

16. The system of claim 10, further comprising:
an advertisement region determining unit to determine an advertisement region for exposing the advertisement of the advertiser based on the average bid price; and
an advertisement exposing unit to expose the advertisement of the advertiser on the determined advertisement region.
